(19) United States
(12) Patent Application Publication
(10) Pub. No.: US 2014/0267029 A1
(43) Pub. Date: Sep. 18, 2014

(54) METHOD AND SYSTEM OF ENABLING INTERACTION BETWEEN A USER AND AN ELECTRONIC DEVICE

(71) Applicants: Alok GOVIL, Fremont, CA (US); Pavankumar Mulabagal, San Jose, CA (US); Marc Maurice Mignard, San Jose, CA (US)

(72) Inventors: Alok GOVIL, Fremont, CA (US); Pavankumar Mulabagal, San Jose, CA (US); Marc Maurice Mignard, San Jose, CA (US)

(73) Assignees: Alok Govil, Fremont, CA (US); Marc Maurice Mignard, San Jose, CA (US); Pavankumar Mulabagal, San Jose, CA (US)

(21) Appl. No.: 13/832,060

(22) Filed: Mar. 15, 2013

(51) Int. Cl. G06F 3/023

(52) U.S. Cl. CPC G06F 3/023
USPC 345/157; 345/168

(57) ABSTRACT

A method and system for enabling interaction between a user and an electronic device includes sensing at least one of position and movement of at least one finger on a physical keyboard, determining position of the finger on the physical keyboard and emulating at least one of a virtual mouse, a virtual touch screen, a virtual hand on a display, and a gesture sensing technique to enable the interaction in accordance to at least one of the position and the movement of the finger. The system includes an electronic device, a communication interface, a memory and a processor.

### TECHNICAL FIELD

Embodiments of the disclosure relate to the field of enabling interaction between a user and an electronic device.

### BACKGROUND

Conventional modes of human-computer interaction use keyboards and text displayed on a monitor for language-based communication, and computer mice and graphics displays for visual communication. A computer mouse senses its physical movements, typically on a mouse pad, and maps a button click performed on the computer mouse to a location of a mouse pointer on the monitor. Using a computer mouse therefore requires dragging the mouse pointer to a desired location on the monitor and then clicking a suitable button on the computer mouse. However, dragging the mouse pointer involves movement of user's hands between the keyboard and the mouse, which is time-consuming and results in fatigue, and careful positioning of the mouse pointer at the desired location on the monitor. Use of a computer mouse is also counter-intuitive as compared to manipulating physical objects directly with hands.

Computer systems use special-purpose keys and key combinations as keyboard shortcuts to perform actions without moving hands away from the physical keyboard. This requires the user to memorize the keyboard shortcuts making the system counter-intuitive. Keyboard shortcuts are also not sufficient for commands requiring spatial context like drag and drop.

A touch-sensor, placed on the top of electronic display screens or other flat surfaces forms a significantly more intuitive system. When used together with a physical keyboard, this method also requires movements of hands between the keyboard and the screen which leads to fatigue and lost productivity. Touch pads are also placed below or near the keyboards especially in laptops and electronic notebooks. The touch pads still require hand movements between keys area of the keyboard and touch pad area. Further, the touch pad area is fairly small for comfortable use.

Alternatively, an on-screen virtual keyboard is used by the touch screen. Such virtual keyboards do not provide tactile feedback leading to inconvenience. Further, the method is not suitable for desktop workstations where the screen and hands are physically separated.

Gesture sensing is an intuitive mechanism that enables sensing user's finger, hand and body movement to enable visual communication. Gesture sensing is accomplished by several methods including optical camera-based or photodiode-based sensing, touch-sensing, inertial sensors like accelerometers, electric-field sensing and time-of-flight measurements with optical or ultrasonic sensors. Interaction with the on-screen graphics and elements is provided by sensing gestures close to the screen.

A conventional method of enabling keyboard portability includes projecting a keyboard image onto a substantially flat surface using a laser light source. Finger movements on top of the flat surface are tracked optically to emulate a virtual keyboard. Such devices also support mouse mode enabled or disabled using a special virtual keyboard key or a gesture. The movement of hands between the mouse and the keyboard is thus reduced. These systems however suffer from lack of tactile feedback from the keyboard leading to inconvenience and also require manuals witching between the keyboard and mouse modes.

Another conventional method includes sensing hand or finger movements on a printed circuit board (PCB). The PCB includes multiple sensors for sensing the hand or the finger movements. However, the method fails to sense individual finger movements and the method restrains from enabling multi-finger or multi-touch operations.

Another conventional method includes use of see-through LCD screens with physical keyboard and hands placed behind the screen. This enables the user to see on-screen elements overlaid on top of the view of the hands allowing the user to virtually manipulate on-screen elements with hands. The method requires complex setups including special lighting arrangements, and also requires positioning the screen very close to the users eyes to enable the hands to go behind the screen.

In the light of the foregoing discussion, there is a need for a method and system to allow the user to comfortably and intuitively interact with an electronic device without having to move the hands away from physical keyboard with minimal hardware components.

### SUMMARY

The above-mentioned needs are met by a method, a computer program product and a system for enabling interaction between a user and an electronic device wherein the functionalities of a computer mouse, touch-screen and gesture sensing are integrated with a physical keyboard by sensing finger position and movement just above the physical keyboard.

An example of enabling interaction between a user and an electronic device includes sensing at least one of position and movement of at least one finger on a physical keyboard. The keyboard being in electronic communication with the electronic device. The method also includes determining position of the finger on the physical keyboard. The method further includes emulating at least one of a virtual mouse, a virtual touch screen, a virtual hand on a display, and a gesture sensing technique to enable the interaction in accordance to at least one of the position and the movement of the finger.

An example of a computer program product stored on a non-transitory computer-readable medium that when executed by a processor, performs a method of enabling interaction between a user and an electronic device, includes sensing at least one of position and movement of at least one finger on a physical keyboard. The keyboard being in electronic communication with the electronic device. The computer program product also includes determining position of the finger on the physical keyboard. The computer program product further includes emulating at least one of a virtual mouse, a virtual touch screen, a virtual hand on a display, and a gesture sensing technique to enable the interaction in accordance to at least one of the position and the movement of the finger.

An example of a system for enabling interaction between a user and an electronic device includes the electronic device. The system also includes a communication interface in electronic communication with the electronic device. The system further includes a memory that stores instructions. Further, the system includes a processor responsive to the instructions to sense at least one of position and movement of at least one finger on a physical keyboard. The keyboard being in electronic communication with the electronic device. The processor is also responsive to the instructions to determine position of the finger on the physical keyboard. The processor is further responsive to the instructions to emulate at least one of a virtual mouse, a virtual touch screen, a virtual hand on a display, and gesture sensing technique to enable the interaction in accordance to at least one of the position and the movement of the finger.

### BRIEF DESCRIPTION OF THE FIGURES

In the accompanying figures, similar reference numerals may refer to identical or functionally similar elements. These reference numerals are used in the detailed description to illustrate various embodiments and to explain various aspects and advantages of the present disclosure.

FIG. 1 is a flow diagram illustrating a method of enabling interaction between a user and an electronic device, in accordance with one embodiment;

FIG. 2 is a block diagram of an electronic device for enabling interaction between a user and a display of the electronic device, in accordance with one embodiment;

FIG. 3 is an exemplary illustration of mounting multiple camera sensors on a keyboard for sensing movement of a finger;

FIG. 4A-4C is an exemplary illustration of electronically connecting a finger sensing device to the electronic device for sensing movement of a finger just above the keyboard;

FIG. 5 is an exemplary illustration of constructing a three dimensional view of the finger to generate a finger image;

FIG. 6 is an exemplary illustration of finger images displayed on a display of an electronic device;

FIG. 7 is a flow diagram illustrating a method of isolating keyboard regions from the finger regions in the camera view;

FIG. 8 is a flow diagram illustrating a method of detecting position and orientation of keyboard in the camera view; and

FIG. 9 is an exemplary illustration of mounting a minor on a keyboard for reducing the number of camera sensors required.

### DETAILED DESCRIPTION OF THE EMBODIMENTS

The above-mentioned needs are met by a method, computer program product and system for enabling interaction between a user and a display of an electronic device. The following detailed description is intended to provide example implementations to one of ordinary skill in the art, and is not intended to limit the invention to the explicit disclosure, as one or ordinary skill in the art will understand that variations can be substituted that are within the scope of the invention as described.

FIG. 1 is a flow diagram illustrating a method of enabling interaction between a user and a display of an electronic device, in accordance with one embodiment.

At step 105, position or movement of a finger of a user, on or just above the keyboard is sensed. Above the keyboard may be considered to be a few centimeters above the keyboard so that the user may not have to substantially lift hands from a resting position. Sensing is performed using multiple camera sensors mounted on the keyboard. In one example, the camera sensors may be complementary metal oxide semiconductor (CMOS) sensors. Low-resolution sensors, for example, Quarter Video Graphics Array (QVGA), Video Graphics Array (VGA) or High definition (HD) may also be used for sensing. Each camera sensor provides still image or video with at least a partial view of the physical keyboard, as well as the user's fingers and hands when in view of the sensor.

The camera sensors are positioned on keyboard such that the position or movement of the finger is sensed, even in presence of failure to capture the finger image due to light blockage by other fingers by one or more of the camera sensors. The camera sensors can also be placed or around the keyboard for sensing the finger movement. In one example, the camera sensors may be positioned at the end of the keyboard closer to the user such that the camera sensors face the palm of the user. In another example, the camera sensors may be positioned on left side and right side of the keyboard.

In some embodiments, sensing the position or movement is performed by arranging lenses, mirrors on the keyboard. The lenses or the mirrors are arranged such that a fewer cameras are adequate to capture the movement of the finger from different directions.

In some embodiments, sensing the position or movement is performed by mounting multiple sensing devices on the keyboard. Examples of the sensing devices include, but are not limited to, photo-diodes, capacitive sensors, inductive sensors, electric-field sensors and ultrasonic sensors. Further, while using light dependent sensors for example, the camera sensors and the photo-diodes, infrared radiation may be used instead of visible light. The infrared radiation enables reduction of impact of ambient lighting and further enables use of infrared LEDs to illuminate viewing area on the keyboard under dark ambient conditions.

Further, in some embodiments, sensing the position or movement is performed by electronically connecting a finger sensing device with the electronic device or the keyboard. The finger sensing device may include multiple camera sensors for sensing the finger position or movement just above the keyboard. The finger sensing device may be connected using a wired or wireless interface. In one example, a leap motion controller device and software application may be used for sensing the finger movement. Also, the finger sensing device may be configured to be bendable such that relative positions of the camera sensors may be changed to capture the movement of the finger from different directions.

At step 110, determining position or movement of the finger is performed from the camera sensor output, say in response to sensed finger movement. Fingers are detected in the camera views received from the camera and distinguished from the keyboard image and background in the same camera views. In one example, if color camera sensors are used, color of skin may be used to distinguish fingers from background.

In one embodiment, motion of several points in the camera views is tracked. The points that are substantially stationary are considered to be a part of the background while those that are moving are considered to belong to the fingers. The position and movement of the fingers is identified from these points.

Further a three dimensional view of the finger position is constructed. A match between various pixels of the camera view from multiple camera sensors is determined. One or more conventional methods can be used to determine the match. In one example, if the cameras are perfectly aligned with each other horizontally, then any given point in three dimensional region will be represented at the same height within the camera views. Thus, pixels in the camera views at each row correspond to each other. In another example, the match is determined between the images based on root-mean-square (rms) distance calculation between the colors or intensities of the pixels under consideration. Matching may be performed for pixels for more than two cameras by repeatedly finding a matching pixel for a second camera view to a pixel in the first camera view until a match is found for all camera views. This is repeated for all points of interest in the camera views, which may include the regions in camera views where movement has been detected or their centroids.

Construction of the three dimensional view is performed using a camera model. A simple camera model may be used where the light rays joining a subject to a location of the subject in the camera view all intersect at a point called the center of projection. In one example, the center of projection may be on the side of the camera view opposite to the subject. Given the position of the subject in the camera view, the subject must lie on the line joining the position and the center of projection.

Given the correspondence between the camera points in the camera views, the points of interest are mapped from two dimensional view to the three dimensional view. Since position and orientation of the cameras is known, the line joining the point in the camera view and the center of projection may be projected towards the location of the three dimensional region of interest just above the physical keyboard.

With more than one camera sensor, the subject must lie on the intersection of these lines from each camera, which is determined to be the three dimensional position of the subject. The method is repeated for all points of interest in the camera views including the regions in camera views.

In one example, if there are two perfectly aligned camera sensors used to capture the position of the finger, then there would be two lines intersecting at a point in the three dimensional space for each matched pixel. In one case, the two lines may not have a common plane and therefore may not intersect due to, for example, an alignment mismatch between the two camera sensors. In such cases, an estimated position of the three dimensional point may be chosen to be appoint that is proximal to the two lines. Further, the camera point that is proximal to the two lines may be used for self-calibration of the camera alignment between the two camera sensors. Similarly, a camera point that is proximal to two or more lines is determined when two or more camera sensors are used. In another example, one or more mathematical techniques, for example, like Hough transform may be used to determine the positions of the three dimensional points of interest.

In some embodiments, the three dimensional view of the finger is constructed using techniques such as time-of-flight or triangulation.

Further, the three dimensional view or position information of the finger is transmitted to the image processor for generating the finger image. As an example, the positions of the fingers when viewed from top may be reconstructed together with the height of the finger tips above the keyboard. The image processor may be embedded within the keyboard or the finger movement sensing device. Alternatively, the finger image can also be obtained by fusing camera views, of the finger, obtained from the camera sensors. The representation of the finger may be the actual sensed image of the finger, an outline or a shadow of the finger, or merely a computer mouse icon.

Furthermore the finger image or representation, that is in correspondence with the position of the finger, is mapped on the display of the electronic device. The user may also be enabled to move the finger representation to one or more locations on the display by moving the actual finger just above the keyboard. The finger representation may be drawn as a translucent shadow such that the user may continue to view the graphic elements underneath the finger display. Also, the finger image may be made less visible or invisible, if the user is typing. Visibility and invisibility of the finger image may be performed based on the data content viewed by the user and the speed of the movement of the finger.

At step 115, a virtual mouse or a virtual touch screen is emulated to enable the interaction in accordance with the position of the finger on or above the keyboard. The interaction is enabled in response to touch of the finger on the keyboard without substantially pressing the key, movement of the finger on or just above the keyboard, or movement of the finger representation on the display of the electronic device. If only one of the fingers is substantially moving, the movement of the finger may be used to directly control the mouse pointer location on the screen. The finger thus acts as a virtual mouse. A mouse-click may be inferred from rapid downward movement of the finger as if the user is clicking on the emulated mouse, or when the surface of the keyboard device or the keys is touched.

Alternatively, the user may move the fingers similar to holding a physical computer mouse in hands and moving it, clicking a button on it, or rotating a scroll wheel on it. Further, the user is also enabled to interact with the display on switching the virtual mouse between right hand and left hand.

A touch event, may be represented as a touch by the user on the keyboard surface or a key, without pressing the key. The position of the touch on the keyboard is mapped to a position on the screen such that the same system response is generated as if by a physical touch screen mounted on the display screen. Alternatively, this may be seen as a virtual touch screen mounted on the surface of the physical keyboard. Further, screen co-ordinates of the display are mapped to the virtual touch screen. Operations like drag and drop may also be performed by touching on the physical keyboard, or putting a finger substantially close to the keyboard, at a desired location, dragging the finger on the keyboard without substantially lifting it up, and finally substantially lifting the finger up to emulate the drop operation. A virtual multi-touch screen is emulated by sensing and tracking multiple fingers.

With a representation of the fingers on the screen, the user may start using the on-screen finger representations as virtual fingers or hands to directly interact with elements displayed on the screen. The elements displayed on the screen may include graphic user interface (GUI) elements like buttons, toolbars, forms, tiles or windows. Alternatively, the user may see these as multiple mouse-pointers which are all activated or controlled by moving the fingers on the physical keyboard device.

Mapping between the display and the virtual touch screen may be performed based on the data content present on the display. Also, the mapping may be non-linear or linear. In one example, it can be considered that the user is less likely to touch large blank areas on the display, and more likely to touch graphical elements present on the display. Hence, the large blank area is mapped to a smaller area on the virtual touch screen and area including the graphical elements is mapped to a larger area on the virtual touch screen. One or more geometrical image deformation techniques may be used for the mapping.

In some embodiments, the data content on the display may be projected on the keyboard using a projector, allowing the user to view the mapping of screen co-ordinates with the virtual touch screen.

The user is also enabled to use the fingers and hands to make gestures sensed by the system. The gestures may be used for commands like scrolling, rotating and resizing elements on the screen using pinch-and-zoom. The gestures may also be used to control software programs requiring three-dimensional (3D) input like 3D games and computer-aided design (CAD) tools.

The mouse, touch or gesture operations may be dependent on the position, trajectory, or speed of the movement. For example, the movement of the mouse pointer on the screen may be controlled by the height of the finger in addition to the movement of the finger. For example, the mouse pointer may be moved only if the finger is close enough to the keyboard. This may allow the user to return the finger back to its original position without moving the mouse pointer back to the original position.

When the user is typing, the system would be sensing the movement of the finger, and also receiving key-press events from the keyboard. Further, the system would optionally also be optically sensing the keyboard key movements. In one embodiment, the system has multiple modes of operation, including at least a keyboard mode, and at least one of mouse, touch or gesture mode. The user's actions are inferred to correspond to the mode that is currently set. A mode may be set by pressing special keys or key combinations on the physical keyboard. A mode may also be set by using special gestures. For example, rapidly lifting hands away from the keyboard may be used to switch to touch screen more and a rapid motion towards the keyboard may be used to switch to the keyboard mode. As another example, the keyboard mode may be implied unless the user's index and middle fingers are touching each other. Another possibility is for the user to touch first hands the index finger and the thumb to each other while performing non-keyboard movements with the other hand.

In another embodiment, if a physical key press event is received from the keyboard in the middle or towards the end of a detected finger motion, keyboard intent is implied and the mouse, touch, or gesture motions are not inferred. If after sensing of a finger movement or when the finger movement stops, a keypress event is not received from the keyboard, mouse, touch or gesture intent of the finger motion may be inferred.

In yet another embodiment, position, trajectory, and/or speed of the movement may be used to distinguish keyboard, mouse, touch and gesture intents of the movement. As an example, the height of the determined trajectory of the motion may be used to infer keyboard intention if it is lower than a threshold and mouse, touch or gesture if it is higher than a threshold. A downward motion for example, vertical or within say 75 degrees of the vertical may be anticipated as typing motion. An upward or substantially sideways motion may be inferred as mouse, touch or gesture motion. It is also possible to have a set of pre-determined motions applicable for a given modality like keyboard, mouse, touch or gestures. For example, only commonly used gestures may be inferred as gestures, while everything else may be considered for other modalities. Likewise, mouse may be inferred only if the user's fingers are all moving together as if holding a physical mouse. Typically, even for slow typists, finger movements intended for mouse or gestures movements are slower than those intended for keyboard or possibly touch, allowing the system to infer the intent of finger movement based on speed of the movement.

In another embodiment, the user's intent may be inferred based on history or context. If the computer cursor is within a text field, or has been placed in a text field very recently by the user, a keyboard intent may be inferred. The system may assume that there is a time interval of for example 0.1 seconds before the user intent changes. So if a keyboard key press event was received for a key from a set of keys within the last 0.1 seconds, none of the finger movements are inferred as mouse, touch or gesture motions. Special keys like Ctrl, Alt, and Shift may not belong to this set of keys since they are often pressed together with mouse operations. For example, a left mouse button click may behave differently if performed with the Shift key pressed.

In yet another embodiment, machine learning algorithms may be used to infer the user intent based on several measured characteristics like detected key press events, speed of finger movement, number of fingers moving and height of the fingers. A machine learning based classifier may be used to analyze the measured parameters of the finger movements and output anticipated intention of the user amongst keyboard, mouse, touch or gesture intents. It is also possible to use cues from other input mechanisms, for example, voice recognition and eye tracking to improve the accuracy of prediction.

Since the key presses received from the keyboard reveal the location of the finger since the location of the key pressed on the keyboard is known, this allows for automatic calibration and fine-tuning of the system without user intervention to improve accuracy of finger position sensing. In another embodiment, cameras views are aligned together by designing the cameras to have at least a partial view of the keyboard keys. Since all the cameras are looking at the very same physical keyboard and overlapping regions thereof to make sure there are no blind spots, the boundary of the keyboard, the keys, and the letters on the keys can serve as relevant beacons for camera alignment.

A variety of methods may be deployed for such alignment and calibration. For example, mapping between two coordinate systems is represented via affine transformations in three dimensions, which has about 6-12 unknown parameters. The system may calculate the estimated position of a finger, later find more information about its position based on the key pressed, compute the estimated error between the two, and use this error to refine the estimates for the unknown parameters using say some generalization of a Kalman filter.

The method enables the user to interact with graphical elements displayed on the display of the electronic device while resting the user's hand on the keyboard, thereby resulting in increased productivity, lower fatigue and reduced repetitive stress injuries.

FIG. 2 is a block diagram of an electronic device for enabling interaction between a user and a display of the electronic device, in accordance with one embodiment.

The electronic device 200 includes a bus 205 or other communication mechanism for communicating information, and a processor 210 coupled with the bus 205 for processing information. The electronic device 200 also includes a memory 215, for example a random access memory (RAM) or other dynamic storage device, coupled to the bus 205 for storing information and instructions to be executed by the processor 210. The memory 215 can be used for storing temporary variables or other intermediate information during execution of instructions by the processor 210. The electronic device 200 further includes a read only memory (ROM) 220 or other static storage device coupled to the bus 205 for storing static information and instructions for the processor 210. A storage unit 260, for example a magnetic disk or optical disk, is provided and coupled to the bus 205 for storing information.

The electronic device 200 can be coupled via the bus 205 to a display 230, for example a liquid crystal display (LCD), for displaying data. The input device 235, including alphanumeric and other keys, is coupled to the bus 205 for communicating information and command selections to the processor 210.

Various embodiments are related to the use of the electronic device 200 for implementing the techniques described herein. In some embodiments, the techniques are performed by the electronic device 200 in response to the processor 210 executing instructions included in the memory 215. Such instructions can be read into the memory 215 from another machine-readable medium, for example the storage unit 260. Execution of the instructions included in the memory 215 causes the processor 210 to perform the process steps described herein.

In some embodiments, the processor 210 can include one or more processing units for performing one or more functions of the processor 210. The processing units are hardware circuitry used in place of or in combination with software instructions to perform specified functions.

The term “machine-readable medium” as used herein refers to any medium that participates in providing data that causes a machine to perform a specific function. In an embodiment implemented using the electronic device 200, various machine-readable media are involved, for example, in providing instructions to the processor 210 for execution. The machine-readable medium can be a storage medium, either volatile or non-volatile. A volatile medium includes, for example, dynamic memory, for example the memory 215. A non-volatile medium includes, for example, optical or magnetic disks, for example the storage unit 260. All such media must be tangible to enable the instructions carried by the media to be detected by a physical mechanism that reads the instructions into a machine.

Common forms of machine-readable media include, for example, a floppy disk, a flexible disk, hard disk, magnetic tape, or any other magnetic media, a CD-ROM, any other optical media, punchcards, papertape, any other physical media with patterns of holes, a RAM, a PROM, and EPROM, a FLASH-EPROM, any other memory chip or cartridge.

In another embodiment, the machine-readable media can be transmission media including coaxial cables, copper wire and fiber optics, including the wires that include the bus 205. Transmission media can also take the form of acoustic or light waves, such as those generated during radio-wave and infra-red data communications. Examples of machine-readable media may include, but are not limited to, a carrier wave as described hereinafter or any other media from which the electronic device 200 can read. For example, the instructions can initially be carried on a magnetic disk of a remote computer. The remote computer can load the instructions into its dynamic memory and send the instructions over a telephone line using a modem. A modem local to the electronic device 200 can receive the data on the telephone line and use an infra-red transmitter to convert the data to an infra-red signal. An infra-red detector can receive the data carried in the infra-red signal and appropriate circuitry can place the data on the bus 205. The bus 205 carries the data to the memory 215, from which the processor 210 retrieves and executes the instructions. The instructions received by the memory 215 can optionally be stored on the storage unit 260 either before or after execution by the processor 210. All such media must be tangible to enable the instructions carried by the media to be detected by a physical mechanism that reads the instructions into a machine.

The electronic device 200 also includes a communication interface 225 coupled to the bus 205. The communication interface 225 provides a two-way data communication coupling to the network 260. For example, the communication interface 225 can be an integrated services digital network (ISDN) card or a modem to provide a data communication connection to a corresponding type of telephone line. As another example, the communication interface 225 can be a local area network (LAN) card to provide a data communication connection to a compatible LAN. In any such implementation, the communication interface 225 sends and receives electrical, electromagnetic or optical signals that carry digital data streams representing various types of information.

The electronic device 200 further includes a sensing device 250 that enables for sensing position or movement of a finger.

The processor 210 in the electronic device 200 is configured to sense position or movement of a finger on or just above the keyboard using a plurality of camera sensors mounted on the keyboard, the keyboard being in electronic communication with the electronic device.

The processor 210, upon sensing the movement, determines position of the finger, say in response to the finger movement. The processor 210 determines the movement by comparing a previous position of the finger and a current position of the finger. Further, the processor 210 also includes noise filtering. Further the processor 210 is configured to determine static positions of the fingers.

The processor 210 is also configured to construct a three dimensional view of the finger position to generate a finger image or representation and further the finger image or representation is projected on a display of the electronic device. The processor 210 transmits the finger information to the image processor for generating the finger image or representation. Processor 210 performs construction of the three dimensional view using a camera model. The position of the finger captured by the camera in the camera view is projected on a three dimensional space just above the keyboard. Projection is performed upon intersection of multiple lines joining from multiple centers of projection of the cameras.

Further, the processor 210 is configured to determine a match between various pixels of the camera views. The processor 210 utilizes one or more conventional methods to determine the match. In one example, if the cameras are aligned with each other horizontally, then any given point in three dimensional region will be represented at substantially the same height or row in the camera views. Thus, pixels in a camera view at each height need to be compared to the pixels in other camera views at the same height. In another example, the match is determined between the images based on root-mean-square (rms) distance calculation between the colors or intensities of the pixels being considered for matching.

Further, the processor 210 may be configured to convert the finger position from two dimensional view to the three dimensional view. The processor 210 may utilize techniques such as time-of-flight and triangulation for constructing the three dimensional view of the finger position.

The processor 210 is configured to map the finger image or representation, that is in correspondence with the position of the finger, on the display of the electronic device. The processor 210 also enables the user to move the finger image to one or more locations on the display. The processor 210 is configured to display the finger image as a translucent shadow such that the user may continue to view the graphic elements underneath the finger image displayed. Also, the processor 210 is operable to make the finger image less visible or invisible, if the user is typing. The processor 210 is operable to control the visibility and invisibility of the finger image based on the data content viewed by the user and the speed of the movement of the finger.

Further the processor 210 is operable to emulate a virtual mouse, a virtual touch screen, or virtual fingers or hands to enable the interaction in accordance with the position of the finger on or just above the keyboard. The processor 210 enables the interaction in response to touch of the finger on the keyboard, movement of the finger on the keyboard or movement of the finger image, by the user, on the display of the electronic device.

Further, the processor 210 is operable to represent a touch, by the user, on the keyboard as a touch event. Further the processor 210 maps the screen co-ordinates of the display with the virtual touch screen. The processor 210 may be operable to project the data content, present on the display, to the keyboard.

The processor 210 is further operable to enable a multi mode operation technique to select keyboard operation or emulation of either the virtual mouse, the virtual touch screen or gesture sensing. In one example, a special key or a combination of keys may be used to enable the multi mode operation technique. In another example, one or more gestures, such as rapidly lifting hands away from the keyboard and rapid motion towards the keyboard may be used for switching between different modes.

FIG. 3 is an exemplary illustration of mounting multiple camera sensors on a keyboard for sensing movement of a finger.

FIG. 3 includes three camera sensors, a camera sensor 305, a camera sensor 310 and a camera sensor 315. The three camera sensors are mounted on the keyboard 320 and each of the camera sensors are positioned to face fingers of a user on or just above the keyboard. The camera sensors are positioned on the keyboard 320 such that the position or movement of the finger is sensed, even in presence of failure to capture the movement due to light blockage by other fingers by one or more of the camera sensors.

For use with laptop keyboards, to allow the laptop lid to close, the camera may be put deeper so that they do not protrude above the surface level of the keyboard.

FIG. 4A-4C is an exemplary illustration of electronically connecting a finger sensing device to the keyboard or the electronic device for sensing movement of a finger.

FIG. 4A includes a camera sensor 405, a camera sensor 410 and a camera sensor 415 placed on the finger sensing device 420. The finger sensing device 420 may also be enabled to fold from the middle allowing the three cameras to lie on a plane. Folding the finger sensing device 420 enables flexibility to the device such that the movement of the finger is captured from any direction. The finger sensing device 420 may also be folded such that the camera sensor 405, the camera sensor 410 and the camera sensor 415 lie along a triangle to enable capturing, scanning and creating of three dimensional photographs of physical objects.

In FIG. 4B the camera sensors are placed below, or on the bottom bezel of the screen of a laptop 425, just like webcams are integrated on the top bezel of the laptop screens. Hence this design allows the laptop lid to be closed without hitting the camera sensors. Further, the camera sensors can also be placed on the sides of the screen. Placing the camera sensors on the sides brings additional advantages such as using the same camera sensors as webcams or stereoscopic or three dimensional webcams. Additionally, placing the camera sensors on the sides allows the camera sensors to be integrated with the finger sensing device 420 that is electronically connected to the laptop 425.

In FIG. 4C, a webcam camera 430 integrated with a laptop 425 is re-used to detect the position or movement of the fingers on or just above the keyboard by enhancing the view of the integrated camera to include the keyboard and the fingers in the view. This may be accomplished by tilting the camera downwards, using a wider field of view, or using a mirror 435.

FIG. 5 is an exemplary illustration of constructing a three dimensional view of the finger to generate a finger image.

Construction of the three dimensional view is performed using a camera model. FIG. 5 includes three camera views. A camera view 515, a camera view 520 and camera view 525. In a simple camera model, the camera may be assumed to be positioned at a point behind a screen. The camera view 515 is a projection of the 3D space in the front of the screen to the screen itself. Light rays joining a subject 505 and 510 to a location in the camera view 515 intersect at a point referred to as a center of projection 530. Similarly, the light rays joining the subject 505 and 510 to a location in the camera view 520 intersect at a point called a center of projection 535. Likewise, the light rays joining the subject 505 and 510 to a location in the camera view 525 intersect at a point called a center of projection 540.

Further, the line joining the point in the camera view 515 and the center of projection 530 is projected towards the location of the three dimensional region of interest just above the physical keyboard.

With more than one camera sensor, the subject must lie on the intersection of these lines from each camera, which is determined to be the three dimensional position of the subject. The method is repeated for all points of interest in the camera views including the regions in camera views where finger is visible.

FIG. 6 is an exemplary illustration of finger images displayed on a display of an electronic device. FIG. 6 includes the finger images that are in correspondence with the positions of the fingers on the top of the keyboard. The finger images are mapped on the display 605 of the electronic device. The user may also be enabled to move the finger images to one or more locations on the display 605 by moving the fingers on top of the keyboard. The finger image may be drawn as a translucent shadow such that the user may continue to view the graphic elements underneath the finger image displayed. Also, the finger images may be made less visible or invisible, if the user is typing. Visibility and invisibility of the finger images may be performed based on the data content viewed by the user and the speed of the movement of the finger.

FIG. 7 shows flow diagram of a method of elimination of keyboard regions from the camera views. If the cameras are mounted on a fixed location on the keyboard, the view of keyboard would already be fixed apart from the variation in lighting conditions and could be used to separate regions of fingers in the camera views from those of the keyboard.

At step 705, regions of the camera view where keyboard is expected are identified. These are known since camera sensors are mounted at fixed locations on the keyboard.

At step 710, brightness and contrast level or image histogram, are adjusted to match those of a keyboard image stored in memory to match the lighting conditions when a stored image was captured. The adjustment is applied to the whole camera view.

At step 715, the stored image is subtracted from the adjusted camera view to substantially eliminate view of the keyboard from the camera view. Alternatively, regions of the adjusted camera view that are similar to the stored image are excluded from further processing.

At step 720, other non-interesting portions are eliminated from the camera view using conventional background elimination and noise reduction algorithms.

At step 725, fingers are identified in the remaining objects in the camera view and the two-dimensional positions and orientations are estimated.

FIG. 8 shows flow diagram of another method of elimination of the keyboard regions from camera views by detecting position and orientation of the keyboard in the camera view.

At step 805, brightness and contrast, or an image histogram, of the camera view are adjusted for compensating for varied lighting conditions when a camera view image is captured.

At step 810, edges are detected in the camera view using conventional image processing methods like Laplacian edge detection.

At step 815, Hough transform is used to find straight lines in the image and also establish the plane of these lines in three dimensions. This plane is also the plane of the keyboard top surface that contributes the largest number of straight lines to the camera view.

Step 815 also includes providing location and orientation of keyboard keys in the camera view.

At step 820, a few letters on the keys are read from the camera view to establish the position and orientation of the keyboard.

At step 825, the regions of the keyboard are eliminated from the camera view using known position and orientation of the keyboard in the camera view. Conventional image segmentation methods may also be used to separate regions of fingers in the camera view from those of the keyboard or the background. The method may be aided by knowledge of the color or grayscale value of the keyboard. The movement is determined by comparing a previous sensor response sensitive to position of the finger and a current sensor response. Further, determining the movement also includes filtering noise using conventional methods. The noise can be originated due to unintentional movement of the user's body or arms, changes in ambient lighting conditions, or reflections or shadows of the finger on the keyboard.

The number and speed at which the camera sensors are operated may be adjusted dynamically based on requirement to reduce power consumption. For example, the camera sensors may be substantially turned off if the user is not using the keyboard device.

FIG. 9 shows a minor 905 placed on the keyboard 320 opposite to camera sensor 305. Line 515 depicts a ray of light reaching the camera sensor, for example the camera sensor 305. A ray of light 910 reaches the camera sensor 305 after reflection from the minor 905. This example apparatus enables using a single camera sensor view to locate a subject point 915 based on its direct and reflected views.

Advantageously, the method specified in the present disclosure enables reduced hand movements between the keyboard, mouse, and touch-screen enabled displays. Hence enabling the human-computer interaction more intuitive. The method also provides for economical means of interaction when compared to virtual on-screen keyboard based technologies due to high cost of touch-screens.

It is to be understood that although various components are illustrated herein as separate entities, each illustrated component represents a collection of functionalities which can be implemented as software, hardware, firmware or any combination of these. Where a component is implemented as software, it can be implemented as a standalone program, but can also be implemented in other ways, for example as part of a larger program, as a plurality of separate programs, as a kernel loadable module, as one or more device drivers or as one or more statically or dynamically linked libraries. Some of the programs may be developed by third-party developers.

As will be understood by those familiar with the art, the invention may be embodied in other specific forms without departing from the spirit or essential characteristics thereof. Likewise, the particular naming and division of the portions, modules, agents, managers, components, functions, procedures, actions, layers, features, attributes, methodologies and other aspects are not mandatory or significant, and the mechanisms that implement the invention or its features may have different names, divisions and/or formats.

While the system and methods are described with respect to a computer keyboard, they may also be extended to other devices like a musical keyboard, synthesizer, piano, etc. As an example, the physical keys may be used for playing notes and chords, while gestures may be used to adjust various settings like voices, instruments, metronome, etc. In a similar fashion, the system may be applied to calculators, phone keypads, remote controls, and even musical instruments like guitars, etc.

Furthermore, as will be apparent to one of ordinary skill in the relevant art, the portions, modules, agents, managers, components, functions, procedures, actions, layers, features, attributes, methodologies and other aspects of the invention can be implemented as software, hardware, firmware or any combination of the three. Of course, wherever a component of the present invention is implemented as software, the component can be implemented as a script, as a standalone program, as part of a larger program, as a plurality of separate scripts and/or programs, as a statically or dynamically linked library, as a kernel loadable module, as a device driver, and/or in every and any other way known now or in the future to those of skill in the art of computer programming. Additionally, the present invention is in no way limited to implementation in any specific programming language, or for any specific operating system or environment.

Furthermore, it will be readily apparent to those of ordinary skill in the relevant art that where the present invention is implemented in whole or in part in software, the software components thereof can be stored on computer readable media as computer program products. Any form of computer readable medium can be used in this context, such as magnetic or optical storage media. Additionally, software portions of the present invention can be instantiated (for example as object code or executable images) within the memory of any programmable computing device.

Accordingly, the disclosure of the present invention is intended to be illustrative, but not limiting, of the scope of the invention, which is set forth in the following claims.

What is claimed is:

1. A method of enabling interaction between a user and an electronic device, the method comprising:
sensing at least one of position and movement of at least one finger on a physical keyboard, the keyboard being in electronic communication with the electronic device;
determining position of the finger on the physical keyboard; and
emulating at least one of a virtual mouse, a virtual touch screen, a virtual hand on a display, and a gesture sensing technique to enable the interaction in accordance to at least one of the position and the movement of the finger.

2. The method as claimed in claim 1, wherein sensing at least one of the position and the movement is performed using a camera sensor mounted on the keyboard.

3. The method as claimed in claim 1, wherein a finger representation, that is in correspondence with the position of the finger, is displayed on the display of the electronic device.

4. The method as claimed in claim 2, wherein the camera sensor is mounted on the lower bezel of a laptop screen with at least a partial view of the keyboard.

5. The method as claimed in claim 1, wherein sensing at least one of the position and the movement is performed by arranging at least one of a plurality of lenses and a plurality of minors on the keyboard.

6. The method as claimed in claim 1, wherein sensing at least one of the position and the movement is performed by a camera viewing the keyboard in at least one mirror.

7. The method as claimed in claim 1, wherein sensing at least one of the position and the movement is performed by mounting a plurality of sensing devices on the keyboard.

8. The method as claimed in claim 1, wherein sensing at least one of the position and the movement is performed by electronically connecting a finger sensing device to at least one of the keyboard and the electronic device.

9. The method as claimed in claim 1, wherein the interaction is enabled in response to one of, touch of the finger on the keyboard, movement of the finger on the keyboard and movement of the finger representation on the display of the electronic device.

10. The method as claimed in claim 1 and further comprising:
enabling of a multi-mode operation technique to select emulation of at least one of a keyboard mode, the virtual mouse, the virtual touch screen and gesture sensing.

11. The method as claimed in claim 1 and further comprising:
enabling the user to interact with on-screen graphic user interface (GUI) elements using the representation of the finger.

12. The method as claimed in claim 1 and further comprising:
determining a group, from a plurality of groups, to which a finger movement belongs for identifying the intent of the user, the plurality of groups comprising at least one of a keyboard typing, a mouse, touch, gesture intents and casual movement of the finger.

13. The method as claimed in claim 1 wherein the keyboard comprises at least one of:
a music keyboard, a synthesizer, a piano, a calculator, a phone keypad and a remote control.

14. A computer program product stored on a non-transitory computer-readable medium that when executed by a processor, performs a method of enabling interaction between a user and a display of an electronic device, the method comprising:
sensing at least one of position and movement of at least one finger on a physical keyboard, the keyboard being in electronic communication with the electronic device;
determining position of the finger on the physical keyboard; and
emulating at least one of a virtual mouse, a virtual touch screen, a virtual hand on a display, and gesture sensing technique to enable the interaction in accordance to at least one of the position and the movement of the finger.

15. The computer program product as claimed in claim 14, wherein sensing at least one of the position and the movement is performed using a camera sensor mounted on the keyboard.

16. The computer program product as claimed in claim 14, wherein a finger representation, that is in correspondence with the position of the finger, is displayed on the display of the electronic device.

17. The computer program product as claimed in claim 15, wherein the camera sensor is mounted on the lower bezel of a laptop screen with at least a partial view of the keyboard.

18. The computer program product as claimed in claim 14, wherein sensing at least one of the position and the movement is performed by arranging at least one of a plurality of lenses and a plurality of mirrors on the keyboard.

19. The computer program product as claimed in claim 14, wherein sensing at least one of the position and the movement is performed by a camera viewing the keyboard in at least one minor.

20. The computer program product as claimed in claim 14, wherein sensing at least one of the position and the movement is performed by mounting a plurality of sensing devices on the keyboard.

21. The computer program product as claimed in claim 14, wherein sensing at least one of the position and the movement is performed by electronically connecting a finger sensing device to at least one of the keyboard and the electronic device.

22. The computer program product as claimed in claim 14, wherein the interaction is enabled in response to one of, touch of the finger on the keyboard, movement of the finger on the keyboard and movement of the finger representation on the display of the electronic device.

23. The computer program product as claimed in claim 14 and further comprising:
enabling a multi-mode operation technique to select emulation of at least one of a keyboard mode, the virtual mouse, the virtual touch screen and gesture sensing.

24. The computer program claim 14 and further comprising:
enabling the user to interact with on-screen graphic user interface (GUI) elements using the representation of the finger.

25. The computer program product as claimed in claim 14 and further comprising:
determining a group, from a plurality of groups, to which a finger movement belongs for identifying the intent of the user, the plurality of groups comprising at least one of a keyboard typing, a mouse, touch, gesture intents and casual movement of the finger.

26. The computer program product as claimed in claim 14 wherein the keyboard comprises at least one of:
a music keyboard, a synthesizer, a piano, a calculator, a phone keypad and a remote control.

27. A system for enabling interaction between a user and an electronic device, the system comprising:
the electronic device;
a communication interface in electronic communication with the electronic device;
a memory that stores instructions; and
a processor responsive to the instructions to
sense at least one of position and movement of at least one finger on a physical keyboard, the keyboard being in electronic communication with the electronic device;
determine position of the finger on the physical keyboard; and
emulate at least one of a virtual mouse, a virtual touch screen, a virtual hand on a display, and gesture sensing technique to enable the interaction in accordance to at least one of the position and the movement of the finger.

28. The system as claimed in claim 27and further comprising:
at least one of a plurality of lenses and a plurality of minors arranged on the keyboard for sensing the movement.

29. The system as claimed in claim 27and further comprising:
a plurality of sensing devices for sensing the movement.

30. The system as claimed in claim 27and further comprising:
a finger sensing device in electronic communication with the keyboard for sensing the movement.

31. The system as claimed in claim 27 and further comprising:
one or more camera devices to construct a three dimensional view of the finger.
